(19) United States
(12) Patent Application Publication
(10) Pub. No.: US 2002/0056127 A1
(43) Pub. Date: May 9, 2002

(54) Video, audio and data on demand

(76) Inventor: Israel Amir, Princeton, NJ (US)

Correspondence Address: RATNER & PRESTIA, P O BOX 980, VALLEY FORGE, PA, 19482

(21) Appl. No.: 09/953,735

(22) Filed: Sep. 17, 2001

Related U.S. Application Data
(60) Provisional application No. 60/232,796, filed on Sep. 15, 2000.

(51) Int. Cl. H04N 7/173; H04N 7/16; H04J 3/24

(52) U.S. Cl. 725/90; 370/473; 370/474; 725/118; 725/148

(57) ABSTRACT

A method for transmitting an on-demand audio or video data file arranges the data file into a sequence of N sections having substantially the same size. The data is then rearranged such that data from a each section is transmitted more frequently than data from a next section in the sequence. The data from the file is arranged in packets such that each packet includes a portion of the data from each of the sections with the portion occupied by the first section being greater than the portion occupied by the second section. Alternatively, the data is arranged in successive groups of packets where each group of packets includes more packets from the first section than from the second section. Data for live programs may use the same scheme where the number of sections or the amount of data in each section increases.

This application claims the benefit of U.S. Provisional application Ser. No. 60/232,796 filed Sep. 15 2000, the entirety of which are incorporated herein by reference.

### FIELD OF THE INVENTION

The present invention concerns a method for providing content on demand and in particular to a method for arranging data in a transmitted data stream to allow for rapid presentation of the content.

### BACKGROUND

The demand for audio and video on demand services is certain to increase. The Internet infrastructure, however, including the backbone bandwidth and the web-servers needed to transmit this content, cannot cope with the increased demand of these broadband services. This situation will worsen as the number of users and the available broadband access grow.

One solution to this problem is to use caching, or similar technologies. Caching solutions can save backbone bandwidth and can increase performance by delivering the content to the end user from the network edge. However, caching solutions are expensive and cannot accommodate the required server load and storage needed to deliver the broadband content to a large number of users. In addition, the required time and bandwidth needed to update the caches at the network's edge is prohibitive if this update is done by unicast. Furthermore, no good solutions exist for on-demand services transmitted via satellite, terrestrial television broadcast or cable television transmissions.

### SUMMARY OF THE INVENTION

The present invention is embodied in a method for arranging a data file for transmission in a manner that enables on-demand access to the content conveyed by the file. The first step in the process is to group the data into N consecutive sections having substantially the same size. The data is then rearranged such that data from a first section is transmitted more frequently than data from a second section, data from the second section is transmitted more frequently than data from a third section, and so on.

According to one aspect of the invention, the data from the file is arranged in packets such that each packet includes a portion of the data from each of the sections with the portion occupied by the first section being greater than the portion occupied by the second section.

According to another aspect of the invention, the data from the file is first packetized and then arranged in successive groups of packets where each group of packets includes more packets from the first section than from the second section.

According to yet another aspect of the invention, the process is applied to content which is increasing is size as it is being broadcast. The process divides the content into sections periodically and transmits the sections such that data from the first section is transmitted more frequently than data from the second section.

### BRIEF DESCRIPTION OF THE DRAWINGS

FIGS. 1, 2, 3, 4, 5A, 5B and 5C are data packet diagrams that are useful for describing the subject invention.

FIG. 6 is a flow-chart diagram that illustrates an exemplary method for forming the data structures shown in FIGS. 1, 2, 3 and 4.

FIG. 7 is a flow-chart diagram that illustrates an exemplary method for forming the data structures shown in FIGS. 5A, 5B and 5C.

FIG. 8 is a graph of worst-case delay versus bandwidth ratio that is useful for describing advantages of the subject invention.

### DETAILED DESCRIPTION

The materials below describe several exemplary embodiments of the invention. In a first embodiment, the content to be broadcast is first divided into packets, for example, 122, 124 and 126 as shown in FIG. 1. The packets are divided into N sections with each section including M packets. In the example shown in FIG. 1, the sections are A 110, B 112, C 114 and D 116, and each section includes six packets. Thus, in the example, N is four and M is six. This example is a simplification that helps to describe the invention. It is contemplated that much larger numbers of sections and numbers of packets in each section may be used in a practical system. The term “transmission” as used to describe the present invention includes, without limitation, sending signals via computer networks, terrestrial broadcast, satellite broadcast and cable television transmissions.

0014 After the packets have been grouped into sections, the data is rearranged to create new packets as shown in FIG. 2. Each new packet 210 is composed of data from packets from all N sections. In the exemplary embodiment of the invention, the first part of the packet 214 is taken from the first section (A). The second smaller part 216 is taken from the second section (13). The last portion 220 in each transmitted packet is small, possibly a single byte, and is taken from the last section (D).

The next new packet 212 in FIG. 2 has the same structure and the relative contributions of the different sections stay the same except that it carries the next portion of data taken from the corresponding sections. For example, if the relative size of the A section in the packet 210 is 20% representing a first fifth of a first A packet 122, the second packet 212 carries the second fifth part of the first A packet 122. Likewise the third packet 213 carries the third fifth of the first A section packet and so on. In the exemplary configuration shown in FIGS. 1 and 2, it takes five new packets to reconstruct a single A packet. Thus, 5M new type packets are used to obtain all packets in the A section. The process for the A section is cyclic in cycle of 5M new packets. Every 5M consecutive new packets contain all the information we need to reconstruct the A section 110. Once all the A section packets have been collected, the method begins to provide the content.

As shown in FIG. 2, the B portion 216 of the packet is somewhat smaller than the A portion 214. This is because while the A section packets are being collected, the B section packets are also being collected (as are all of the other section packets). There is, however, extra time to collect the packets in the B section while the A section packets are playing its part of the broadcast. Thus, the cycle of the B section portion in the new packet is larger than the A section cycle. The C section portion in the packets is even smaller because there is still more time to collect packets from this section before it is provided to the user. Thus, its cycle may be even larger. The portion of the last (e.g. D) section is the smallest and its cycle desirably signifies the broadcast cycle. Clearly, it is desirable for the bandwidth of the system to be larger than the broadcast bandwidth for this technique to be powerful, because a relatively large amount of redundant information is transmitted in order to enable users requesting the data at different times to be able to receive the content, from the beginning, with only a relatively small delay. In addition, it is desirable for the last section of the file to be captured within the broadcast time frame (plus the wait time for the first section to download).

Continuing with the example described above, in which the A section portion is 20% of the packet size then the data length collected before starting the broadcast is 5M packets. In general, the presentation of the broadcast data may begin after the delay defined by equation (1):

$$D = \frac{1}{α N} , \qquad ( 1 )$$

where α is the relative portion of the first section in each transmitted packet. In one exemplary system, a may set to 0.2 and the file may be divided into 60 sections. In this example, presentation of the content of the file may begin after 1/12 of the number of packets in the original file have been collected. Note that this does not correspond to 1/12 of the broadcast time (but less) because it is assumed that the last link bandwidth is larger than the broadcasting bandwidth thus collecting the first 1/12^{th} of the data happens in much less than 1/12^{th} of the broadcast time.

In the following analysis the new method is compared to another possible method of utilizing one-to-many transmissions for audio/video on demand. In both methods, it is assumed that the one-to-many transmission is transmitted cyclically, i.e., once the broadcast is over it starts immediately again. A user may enter the one-to-many transmission at an arbitrary point and wait until the start of the next cycle of the broadcast to begin the presentation. It is also assumed that the available system bandwidth is larger than the broadcast rate. For example, broadcast of 14.4K may be carried by a 56K one-to-many transmission system.

The following case is analyzed: a video-on-demand one-to-many transmission of 60 minutes is divided into 60 sections. Each of the sections is 1 minute long. The one-to-many transmission rate is about 4.7 times the broadcast rate (this ratio is defined as a bandwidth ratio). The packet structure of the first few sections is the following (only 11 out of the 60 are shown. Note that the sum of all the portions is 1):

TABLE 1

| section number | Portion of section |
|---|---|
| 1 | 0.2129 |
| 2 | 0.1065 |
| 3 | 0.0710 |
| 4 | 0.0532 |
| 5 | 0.0426 |
| 6 | 0.0355 |
| 7 | 0.0304 |
| 8 | 0.0266 |
| 9 | 0.0237 |
| 10 | 0.0213 |
| 11 | 0.0194 |

If the “cyclical” method were used, the viewer would have to wait up to approximately 12 minutes for a broadcast. This is because with the wide bandwidth available one can speed up the downtime to about ⅕ of the broadcast time—this translates to about ⅕ of 60 minutes. If, however, the new method is employed, the view would wait only about 1 minute to begin viewing the broadcast. This is because the view accumulates only about five times more packets that appear in the first section as the A portion takes about 20% of the packet. Because the bandwidth is about five times the broadcast rate, however, these packets may be collected in about a minute.

FIG. 8 shows the behavior of a method according to the subject invention for a variety of bandwidth ratios (points 810) and compares it to similar points 812 representing the cyclic method. Both examples are for a file sectioned into 60 sections.

It is important to note that instead of using packets having a structure similar to that shown in FIGS. 1 and 2, one can use groups of packets taken from the different sections and build a structure that is similar to the one shown in FIG. 2.

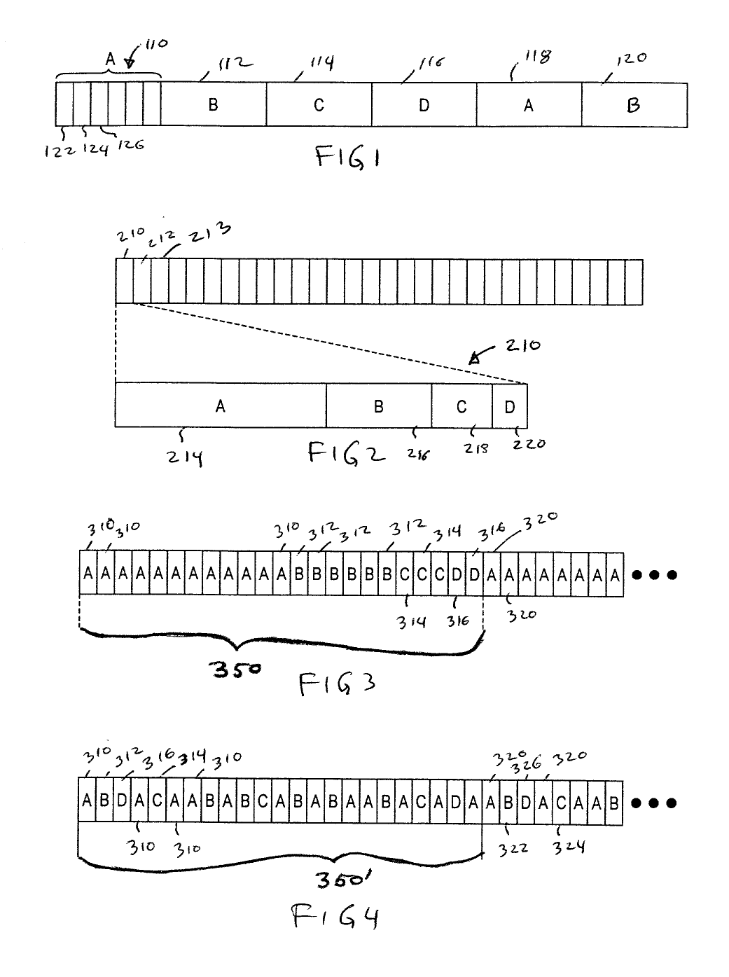

This method is illustrated by FIGS. 3 and 4. First, the signal is sectioned into the same N sections as shown in FIG. 1. But instead of transmitting new type of packets as shown in FIG. 2. The original packets are sent but following an overall structure that is similar to the packet structure shown in FIG. 2. Thus, instead of having a new packet structure, the new transmission implements a new organization of the existing packets.

The new transmission structure is shown in FIG. 3. First, there are many packets 310 of the A section, then fewer packets 312 from the B section and still fewer packets 314 and 316 from each of the C and D sections, respectively. The size of the structure is desirably much smaller (say thousands) than the number of packets in a section (may be millions). In this description, the new repeating structure of groups of packets is known as Backets (Big Packets). Backets are thus a large collection of packets that each has contributions from all sections of the file with known relative quantities. FIG. 3 shows an exemplary Backet 350. One can look at the new transmission organization as composed of large repeating structures with the same order and relative sizes of the regions as the one shown in FIG. 2. The main advantage here is that the same type of packets are transmitted as in the original content. This is just an illustration to better understand the method. In practice, one may randomize the packets, as shown in FIG. 4, within a cycle to reduce the impact of dropped packets. FIG. 4 shows an exemplary randomization in which the A packets 310, B packets 312, C packets 314 and D packets 316 are shuffled to form the modified Backet 350′. To allow the individual packets to be presented in proper order, each packet may include a sequence number that allows the receiver to place the packet in its proper position in the recovered file.

As a further alternative implementation of the invention, if, during one of the basic cycles (basic cycle is the time it takes to transmit M packets) there are no requests for “on demand” service. The time in the cycle can be used to change the structure of the Backets such that the first section packets are not transmitted thus providing more time to transmit and supplement (for dropped packets) the current users. When new requests come later the basic original Backet structure may be reinstated.

FIG. 6 is a flow-chart diagram which illustrates a one-to-many transmission method as shown in FIGS. 1-4. At step 610, the process receives new content. In this embodiment of the invention, the new content is an entire file that may represent, for example, a one-hour video program. Next, at step 612, the file is divided into sections, in this example, 60 one-minute sections. At step 614, the sections are divided into subsections. In the embodiment of the invention described above with reference to FIGS. 1 and 2, these subsections may be portions of a packet, with the size of the packet portions decreasing with increasing section number. With reference to FIGS. 3 and 4, the subsections may be individual packets. Next, at step 616, the subsections from each section are combined to generate the output data stream. In the embodiment described in FIGS. 1 and 2, individual packets of the output signal may be generated by combining one subsection from all of the sections. In the embodiment of FIGS. 3 and 4, a number of packets from each section may be combined to form a Backet. The number of packets for each section in the Backet decreases with increasing section number. Next, at step 618, the process determines if the last subsection of the last packet has been processed. If not, step 620 is executed which increments the various section pointers, with a modulus of the section size, and branches to step 616, described above. If the last subsection of the last section has been processed then, at step 622 the process determines whether the data is to be broadcast again. If so, then step 624 resets all of the pointers to their base position and returns control to step 616. Otherwise, the process branches to step 618 to receive and process new content.

The examples described above have assumed that all of the data corresponding to the one-to-many transmission is available before the transmission begins. This is not the case for some types of programming, for example, a live broadcast. Clearly, the end of a live broadcast can not be predicted before it ends. It is possible, however, to start the On Demand Service while a live broadcast is ongoing. The result may be achieved in one of the following ways: (1) divide the part of the broadcast that already occurred to N sections (the same number of sections into which it would be divided if it were complete and offer it on demand). Naturally, each of the sections is smaller than the length of a section in the final version of one-to-many transmission as the “file” size is smaller.

The audio/video/data stream is transmitted (e.g. on a different channel than the live one-to-many transmission) in the same manner described above. When a new client requests to join the broadcast and wants to see it from the beginning he or she is transferred to the on demand one-to-many transmission (vs. The live transmission). The time that the new client waits before viewing the start of the transmission depends on how much of the program has already been broadcast. If the viewer joins within a few minutes from the start the wait period will be short (as each one of the N sections is small). As the difference between the start of the live broadcast to the point when a client joins in increases, the length of time that a client may need to wait for the “on demand” service also increases. This is a self adjusting process. As the live transmission goes on, the length of each section progressively grows to a point where the length of the sections is the same as in the final version. Alternatively, the length of the sections may be held constant but there may be fewer sections early in the “on demand” service. This method may be simpler to implement.

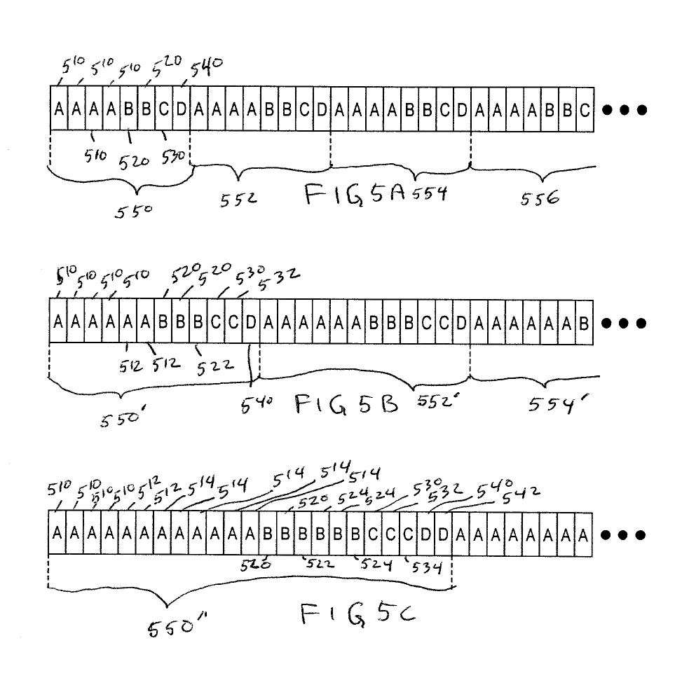

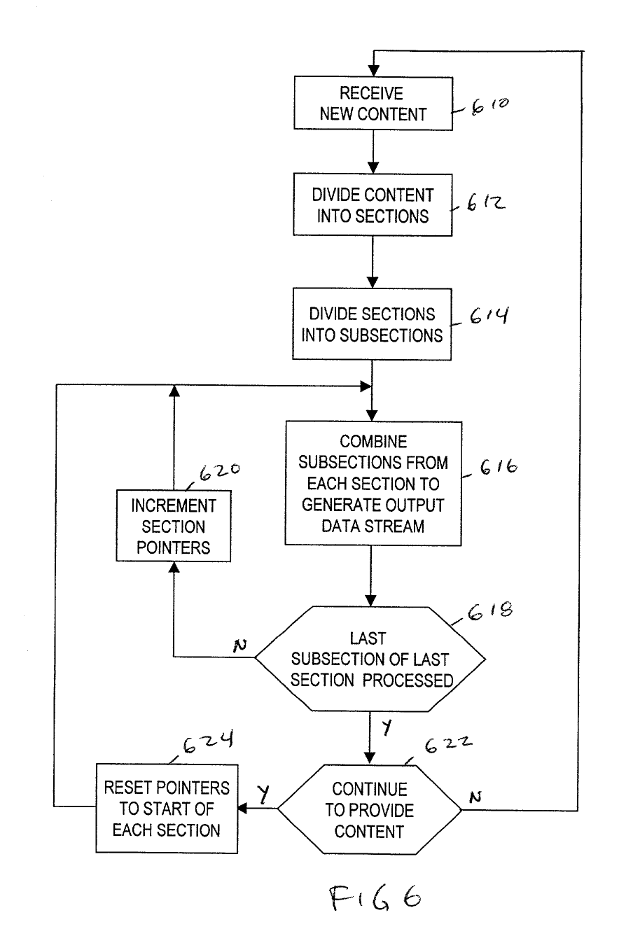

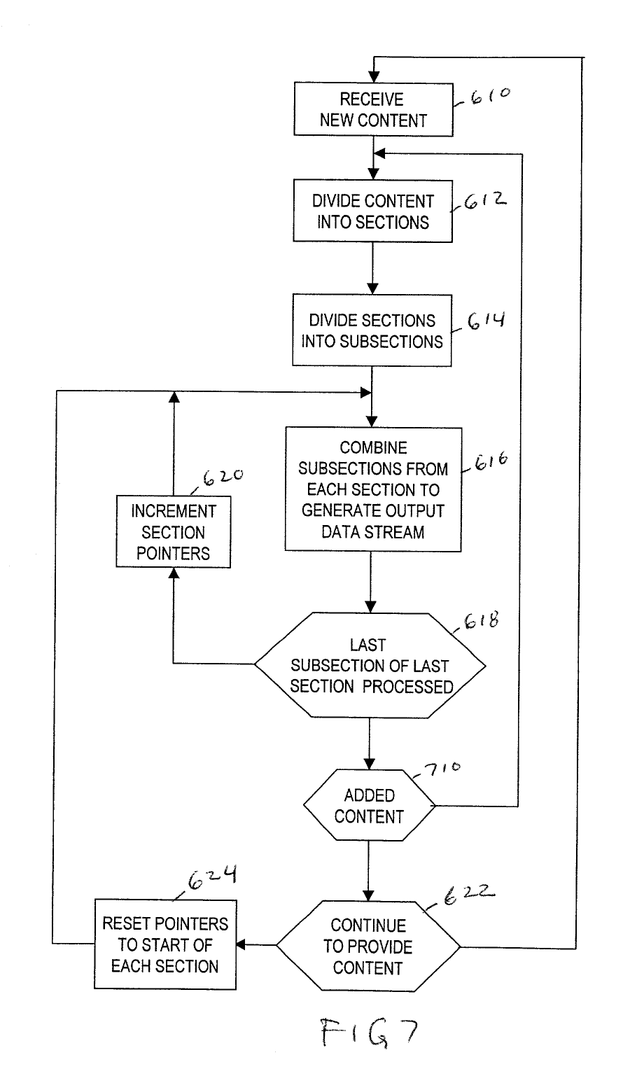

FIGS. 5A, 5B and 5C illustrate the operation of the invention to provide on-demand access to a growing file. As shown in FIG. 5A, the file is relatively small and divided into four sections, A, B, C and D. The packets of each section are arranged into Backets, as described above. As shown in this example, each Backet includes four packets 510 from the A section, two packets 520 from the B section and one packet each 530 and 540 from the C and D sections. As the data file grows, additional packets are added to each Backet. As shown in FIG. 5B, A section packets 512, a B section packet 522 and a C section packet 532 are added. Similarly, as the file grows further, other packets are added, as shown in FIG. 5C. These include A section packets 514, B section packets 524, a C section packet 534 and a D section packet 542.

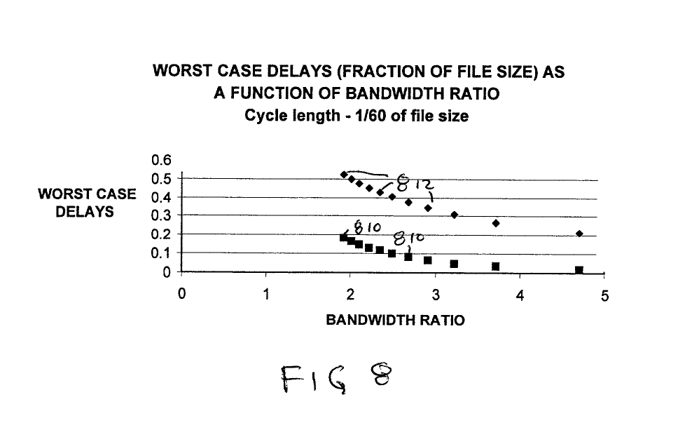

FIG. 7 is a flow-chart diagram that illustrates an on-demand one-to-many transmission of a growing file, for example, the video data from a “live” event. This process is invoked when sufficient data from the live event has accumulated. Typically, this data represents only the first part of the event. This process is essentially the same as the process described above with reference to FIG. 6 except for step 710. This step is executed after the last subsection of the last section has been processed. Step 710 determines if new content has been added relative to what was transmitted earlier. If so, then, step 710 branches to step 610 to obtain the new content. Alternatively, the process may be modified to add sections as the content increases and step 710 may branch (not shown) to step 614 to form subsections for the added sections and combine them with the existing sections in the continuing transmission.

It is contemplated that the invention may be embodied in computer program instructions that control a computer to perform the described process. These instructions may be embodied in a computer-readable carrier such as an memory card, an optical or magnetic disc or a radio-frequency or audio frequency carrier wave.

Although the invention has been described in terms of an exemplary embodiment, it is contemplated that it may be practiced as described above within the scope of the attached claims.

The invention claimed is:

1. A method for transmitting a data file in a manner that enables on-demand access to the content conveyed by the file, comprising the steps of:
grouping the data in the file into a plurality of consecutive sections;
rearranging the data in the file to repeat data from each one section of the plurality of successive sections more frequently than data from each successive section, following the one section in the plurality of consecutive sections; and
transmitting the rearranged data, whereby a user receiving the transmitted data may begin to process the data after a first section of the plurality of consecutive sections has been received.

2. A method according to claim 1, wherein the step of rearranging the data in the file includes the step of arranging the data in packets such that each packet includes a portion of the data from each of the sections, wherein the portion occupied by the data from the one section in each packet is greater than the portion occupied by the data from each of the successive sections.

3. A method according to claim 1, wherein:
the step of grouping the data includes the step of forming multiple packets from the data in the file, wherein each section includes a plurality of the multiple packets; and
the step of rearranging the data in the file includes arranging the packets in successive groups of packets where each group of packets includes more packets from the one section than from each of the successive sections.

4. A method according to claim 3, wherein the step of arranging the packets in successive groups of packets further includes the step of randomizing in order the packets in the group of packets.

5. A method according to claim 1, further including the steps of:
monitoring requests for access to the transmitted data; and
when no requests for access to the transmitted data have occurred within a predetermined interval, suppressing transmission of data in a first section of the plurality of consecutive sections such that the step of rearranging the data file rearranges the data in the file such that data from a second section repeats more frequently than data from any subsequent section in the plurality of successive sections and data from the first section is absent.

6. A method for transmitting a data file that is increasing in size over time, in a manner that enables on-demand access to the content conveyed by the file comprising the steps of:
a) grouping the data in the file into a plurality of consecutive sections;
b) rearranging the data in the file to repeat data from each one section of the plurality of consecutive sections more frequently than data from each successive section, following the one section in the plurality of consecutive sections;
c) transmitting the rearranged data, whereby a user receiving the transmitted data may begin to process the data after a first section of the plurality of successive sections has been received; and
d) repeating steps a), b), c) and d) as the size of the data file increases.

7. A method according to claim 6, wherein the step of rearranging the data in the file includes the step of arranging the data in packets such that each packet includes a portion of the data from each of the sections, wherein the portion occupied by the data from the one section in each packet is greater than the portion occupied by the data from the each of the successive sections, and the number of sections increases as the size of the data file increases.

8. A method according to claim 6, wherein:
the step of grouping the data includes the step of forming multiple packets from the data in the file, wherein each section includes a plurality of the multiple packets and the number of sections increases as the size of the data file increases; and
the step of rearranging the data in the file includes arranging the packets in successive groups of packets where each group of packets includes more packets from the one section than from each of the successive sections.

9. A method according to claim 6, wherein the step of rearranging the data in the file includes the step of arranging the data in packets such that each packet includes a portion of the data from each of the sections, wherein the portion occupied by the data from the one section in each packet is greater than the portion occupied by the data from each of the successive sections, and the amount of data in each of the sections increases as the size of the data file increases.

10. A method according to claim 6, wherein:
the step of grouping the data includes the step of forming multiple packets from the data in the file, wherein each section includes a plurality of the multiple packets and the amount of data in each of the plurality of consecutive sections increases as the size of the data file increases; and
the step of rearranging the data in the file includes arranging the packets in successive groups of packets where each group of packets includes more packets from the one section than from each of the successive sections.

11. A method according to claim 10, wherein the step of arranging the packets in successive groups of packets further includes the step of randomizing in order the packets in the group of packets.

12. A method according to claim 6, further including the steps of:
monitoring requests for access to the transmitted data; and
when no requests for access to the transmitted data have occurred within a predetermined interval, suppressing transmission of data in a first section of the plurality of consecutive sections such that the step of rearranging the data file rearranges the data in the file such that data from a second section repeats more frequently than data from any subsequent section in the plurality of successive sections and data from the first section is absent.

13. A computer readable carrier that includes computer program instructions that cause a computer to perform a method for transmitting a data file in a manner that enables on-demand access to the content conveyed by the file, the method comprising the steps of:
grouping the data in the file into a plurality of consecutive sections;
rearranging the data in the file to repeat data from each one section of the plurality of successive sections more frequently than data from each successive section, following the one section in the plurality of consecutive sections; and
transmitting the rearranged data, whereby a user receiving the transmitted data may begin to process the data after a first section of the plurality of consecutive sections has been received.
